(19) United States
(12) Patent Application Publication
(10) Pub. No.: US 2006/0221340 A1
(43) Pub. Date: Oct. 5, 2006

(54) Online grey balance with dynamic highlight and shadow controls

(75) Inventors: R. Enrique Viturro, Rochester, NY (US); Lalit K. Mestha, Fairport, NY (US)

Correspondence Address: ORTIZ & LOPEZ, PLLC, P.O. BOX 4484, ALBUQUERQUE, NM, 87196-4484, US

(73) Assignee: Xerox Corporation

(21) Appl. No.: 11/097,727

(22) Filed: Apr. 1, 2005

(51) Int. Cl. G01J 3/46

(52) U.S. Cl. 356/402

(57) ABSTRACT

Tone reduction curves are utilized to map an input value to an output value. A tone reduction curve is normally produced by an algorithm that fits a curve to a series of knots. Knots can be determined from calibration data. Printing a calibration patch pattern yields a target patch pattern. The desired reflectances of the calibration patches and the measured reflectances of target patches can be used as calibration data. The series of knots can also include a highlight knot and a shadow knots so that the tone reduction curve functions better in the highlight and shadow regions.

### TECHNICAL FIELD

Embodiments are generally related to printing methods and systems. Embodiments are also related to developing tone reproduction curves that facilitate consistent and accurate printing of highlights, midtones, and shadows.

### BACKGROUND

Printing is the art of producing a pattern on a substrate. The substrate is usually paper and the pattern is usually text and images. A marking engine performs the actual printing by depositing ink, toner, dye, or similar patterning materials on the substrate. For brevity, the word “ink” will be used to represent the full range of patterning materials. In the past, the pattern was introduced to the marking engine in the form of a printing plate. Modernly, digital data is commonly used to specify the pattern. The pattern can be a data file stored in a storage device.

People often desire to produce a pattern using different marking engines. When many copies of the pattern are desired it is convenient to use many marking engines. For example, a publisher believing that a book will be very popular might wish to print millions of copies of the book. The publisher can use dozens of marking engines to produce all those copies. One risk that the publisher faces is that different marking engines produce copies that appear different. One marking engine can produce dark copies. Another might produce copies that look too red. Furthermore, marking engines change over time. As such, the marking engines must be calibrated and maintained so that they all produce similar copies all of the time.

FIG. 1, labeled as prior art, illustrates a marking engine 102 undergoing calibration. A storage device 101 stores a calibration patch pattern 111 in the form of data. The calibration patch pattern 111 includes a number of calibration patches and every calibration patch has a desired reflectance. As such, the storage device 101 also stores desired reflectances 109. A reflectance can specify any color, including black and shades of gray. The marking engine 102 accepts the calibration patch pattern and prints a target patch pattern 103. The target patch pattern 103 includes target patches 104. Every target patch 104 is associated with a calibration patch because every target patch 104 results from the printing of a calibration patch.

A reflectance measuring device 105 measures the target patches 104 to produces target reflectances 110. One example of a reflectance measuring device is the inline spectrophotometer disclosed in U.S. Pat. No. 6,384,918 to Hubble et al, which issued on May 7, 2002 and which is incorporated herein by reference. In general, a target reflectance is the reflectance measurement that the reflectance measuring device 105 obtains from a target patch 103. The target reflectances 110 and the desired reflectances 109 are utilized by a processor 106 to produce a tone reproduction curve 107. The tone reproduction curve 107 can then be stored on a storage device 108.

FIG. 2, labeled as prior art, illustrates one possible target patch pattern 201. There are ten different target patches in the illustrated target patch pattern 201. The black patch 202 is the patch that is most saturated with black ink or toner. The 90% patch 203 is supposed to be 90% as dark as the black patch 202. The 10% patch 204 is supposed to be 10% as dark as the black patch 202. The paper outside of and between the patches can be measured to find the reflectance of unpatterned substrate areas. The target patch pattern of FIG. 2 uses only black ink. Target patch patterns can also be printed with colored inks, such as cyan ink, magenta ink, and yellow ink.

FIG. 3, labeled as prior art, shows some possible relationships between patch patterns, color spaces, and measurements. A color space is used to describe colors. For example, the Pantone colors are a color space commonly used by graphic artists to identify different colors. Another color space is called L*a*b* where L, a, and b are used to specify color coordinates. One of the most important properties of L*a*b* is that it is invariant. An L*a*b* color will always be the same regardless of when or how it is produced and in particular what device it is produced by.

A different color space, CMYK, is commonly used in printing. The letters CMYK refer to the cyan, magenta, yellow, and black inks that printers often use. Cyan, magenta, and yellow are primary colors because mixing them produces the other colors that a marking engine can produce. The problem with CMYK is that it is not invariant because various reasons. One such a reason is that inks, their pigments, are not naturally balanced and their equal combination do not produce a neutral gray. Another reason is that different inks from different sources mix differently on different substrates. For example, in one situation, a certain combination of cyan, magenta, and yellow ink will produce a particular shade of gray. In another situation, the combination could produce a greenish gray.

A L*a*b* pattern 301 can be used to specify the desired output from a marking engine. Mapping between color spaces 302 produces a CMYK pattern 303 from the L*a*b* pattern. The mapping can be different for different situations because L*a*b* is invariant and CMYK is not. Mapping for a specific marking engine 305 involves using tone reduction curves (TRCs) 304 to adjust the CYMK pattern 303 to produce a CMYK pattern ready for printing 306. The pattern can then be printed on the substrate. Usually, nothing more is done once the printed pattern is produced.

More, however, can be accomplished. For example, the printed pattern can be measured 308 for quality control or calibration purposes. A measuring device, such as the in-line spectrophotometer disclosed in U.S. Pat. No. 6,384,918, can measure the reflectance of some areas of the printed pattern to produce an L*a*b* target reflectance 309. Comparing the L*a*b* pattern 301 to the L*a*b* target reflectance 309 can reveal the differences between the marking engine's desired output and its actual output. In quality control scenarios, small enough differences can indicate acceptable quality. In calibration scenarios, the differences can be used to adjust the TRCs. Proper adjustment of the TRCs can minimize the differences.

In calibration scenarios, the L*a*b* pattern 301 can be a calibration patch pattern. When a calibration patch pattern is printed, the printed pattern is a target patch pattern such as that shown in FIG. 2. TRCs 304 can be used during calibration, but it is sometimes more convenient not to use them. When no TRC is used, the CMYK pattern 303 and the pattern ready for printing 306 are equivalent. A target patch pattern is measured by determining the reflectance of individual patches in the pattern. Furthermore, target patch patterns can have patches of many different colors. For example, a target patch pattern can have cyan, magenta, yellow and black patches. It can have gray patches produced with black ink. It can have gray patches produced by printing a combination of cyan, magenta, and yellow inks. In general, a target patch pattern can have patches of any color, shade, or saturation that is obtainable with the inks and the marking engine.

FIG. 4, labeled as prior art, illustrates a TRC for one of the color separations. The illustration is not to scale. TRCs can be used to adjust the amount of ink used. The input axis 401 and the output axis 402 are both shown to have saturation values ranging from 0 to 255. A value of 0 indicates no saturation because no ink is deposited on the substrate. A value of 255 indicates complete saturation because as much ink as possible is deposited on the substrate. Saturation values between 0 and 255 indicate intermediate amounts of ink are deposited. Without a TRC, a request for 100 yellow results in a corresponding amount of ink. With a TRC, a request for 100 yellow can be mapped to a different amount of ink. In FIG. 4, 100 units of ink are input 403. The TRC maps the input to the output, here 100 input 403 is mapped to 107 output 404. The TRC of FIG. 4, maps a request for 100 units of ink into a request for 107 units of ink.

An example of the usefulness of TRCs is using cyan, magenta, yellow, and black inks to produce a process gray. A process gray is a gray that is ideally created by depositing no black ink and equal amounts of cyan, magenta, and yellow inks. Marking engines typically deposit an amount of ink other than that requested. The desired gray in this example is ideally made by depositing 128 cyan, 128 magenta, 128 yellow, and 0 black. The marking engine used, however, deposits 128 cyan when 131 is requested, 128 magenta when 127 is requested, 128 yellow when 130 is requested, and 0 black when 0 is requested. TRCs can adjust the requested amounts so that the marking engine is requested to deposit 131 cyan, 127 magenta, 130 yellow, and 0 black. The marking engine then actually deposits 128 cyan, 128 magenta, 128 yellow, and 0 black to produce the desired process gray.

A different TRC can be used for every ink that a marking engine uses. A CMYK marking engine can have four TRCs. TRCs can have different ranges of saturation values, such as 0 to 1, 0 to 100. 0r 0-255. Regardless of the input range and output range, all TRCs are used to adjust the amount of ink deposited by mapping an input value to an output value.

Determining TRCs for different marking engines, inks, and substrates is a time consuming task. Typically, a patch pattern, such as that shown in FIG. 2, is printed and then measured. The patch pattern is made of patches of different colors and saturations. After printing, the reflectances of the patches can be measured. The desired reflectances and the measured reflectances can be used as calibration data.

FIG. 5, labeled as prior art, illustrates a graph 501 with five knots denoted by squares. The illustration is not to scale. Each knot is produced by analyzing the calibration data from a patch. One knot 502 indicates that requesting a saturation value of 180 produced a saturation value of 175. Another knot 503 indicates that requesting a saturation value of 120 produced a saturation value of 117. As such, if a 117 saturation value is desired, then a TRC can be used to map 117 to 120 because, as just discussed, requesting 120 produced 117. A TRC 504 can be created from the five knots of FIG. 5 by interpolating or curve fitting. The TRC 504 has highlight 506 and shadow 505 regions as discussed below.

Determining TRCs using calibration data and interpolation or curve fitting works well over most of the range of saturation values. However, it does not work well for highlights or shadows. A highlight is a color or shade with a very low saturation value, meaning very little ink is deposited on the substrate. Given a 0 to 255 saturation value range, highlights typically occur from 0 to 20. A shadow is a color or shade with a very high saturation value, typically over 230 on a scale of 0 to 255.

Calibration data for highlights is difficult to produce because the marking engine is not capable of reliably depositing the requested amount of ink and the sensing of the color is noisy. First, most marking engines can reliably deposit average quantities of ink, but not small quantities. Second, the contribution of the substrate to the sensing measurements is larger, and that introduces a noise factor in the measurements. As such, the highlight region of most TRCs has low quality because the calibration data tends to be low quality.

The shadow regions of most TRCs also have low quality. As ink is deposited on a substrate, the substrate is colored by and saturated by the ink. Eventually, adding more ink doesn't change the color much because it is fully, or almost fully, saturated. Here, full saturation is based on the physical arrangement. A color is fully saturated if more ink doesn't change the color. A color is also fully saturated if the marking engine can't deposit any more ink. A person can specify a color that is more saturated than the physical arrangement can deliver. The TRC in the shadow region can be low quality because of the physical arrangement and the user specifications.

A need therefore exists for producing TRCs that work well over all saturation values, including highlights and shadows.

### BRIEF SUMMARY

Aspects of the embodiments address limitations and flaws in the prior art by supplying data to produce better TRCs for highlights and shadows.

It is an aspect of the embodiments to produce a target patch pattern by using a marking engine to print a calibration patch pattern on a substrate. The calibration patch pattern includes at least two calibration patches. Each calibration patch is developable and has a desired reflectance. When the target patch pattern is produced, each calibration patch is printed as a target patch.

It is also an aspect of the embodiments to obtain target reflectances by measuring target patches that are in the target patch pattern. At least two target reflectances can be obtained because the target patch pattern has at least two target patches.

It is a further aspect of the embodiments to determine a target highlight value from data that includes an input highlight value, the target reflectances, and the desired reflectances.

It is a yet further aspect of the embodiments to obtain calibration data that includes at least one target saturation and at least one maximum desired saturation. Target saturation relates to the amount of ink that is deposited on a substrate. The target saturation can be the maximum amount of a particular ink that the marking engine can deposit on the substrate. The particular ink can be black or a primary color such as cyan, magenta, or yellow. Calibration data can be used to produce a tone reproduction curve.

It is a still yet further aspect of the embodiments that a user can select a target saturation for any of the inks, including cyan, magenta, yellow, or black, that a marking engine uses. When a target saturation is user selected, a calibration patch based on the user selected saturation can be printed to produce a target patch. The target reflectance obtained by measuring the target patch can be included in the calibration data used for producing a tone reproduction curve.

It is another aspect of the embodiments that a storage device stores a calibration patch pattern and that the calibration patch pattern includes at least two calibration patches. A marking engine can produce a target patch pattern by printing the calibration patch pattern.

It is yet another aspect of the embodiments that a color measuring device can measure the target patch pattern and obtain at least two target reflectances. A processor can use calibration data that includes the target reflectances and an input highlight value to produce a target highlight value and a tone reproduction curve. A storage device can store the tone reproduction curve. In many cases, a single storage device can be used to store calibration patch patterns and tone reproduction curves.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1, labeled as prior art, illustrates producing a TRC;

FIG. 2, labeled as prior art, illustrates one possible target patch pattern;

FIG. 3, labeled as prior art, shows some possible relationships between patch patterns, color spaces, and measurements;

FIG. 4, labeled as prior art, illustrates a TRC;

FIG. 5, labeled as prior art, illustrates a graph 501 with five knots denoted by squares;

FIG. 6 illustrates finding a target highlight value in accordance with an aspect of the embodiments;

FIG. 7 illustrates choosing a target saturation and determining a TRC in accordance with an aspect of the embodiments.

FIG. 8 illustrates a high level flow diagram of producing a TRC;

FIG. 9 also illustrates a high level flow diagram of producing a TRC;

FIG. 10 illustrates producing a TRC; and

FIG. 11 illustrates producing a TRC.

### DETAILED DESCRIPTION

The particular values and configurations discussed in these non-limiting examples can be varied and are cited merely to illustrate embodiments and are not intended to limit the scope of the invention.

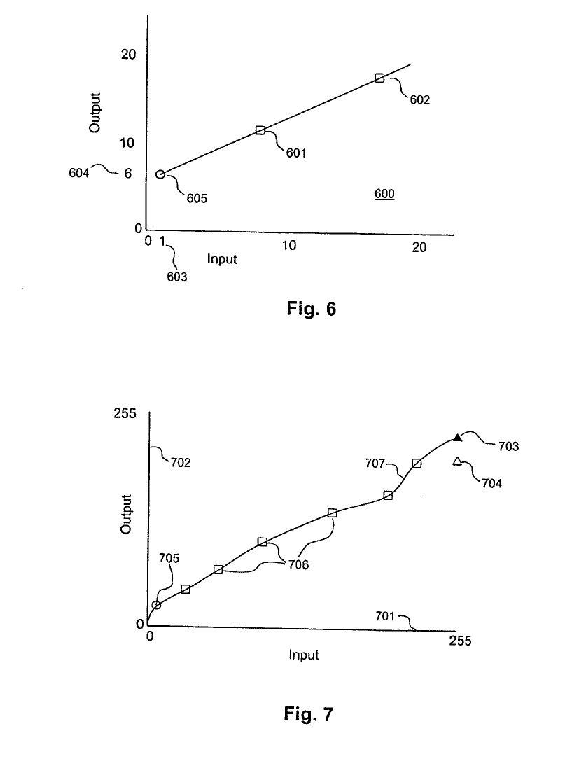

FIG. 6 shows a first knot 601 and a second knot 602 denoted by squares on a graph 600. The illustration is not to scale. The first knot 601 and the second knot 602 can be determined by evaluating calibration data. As discussed above, a target patch pattern, consisting of target patches, is obtained when a calibration patch pattern, consisting of calibration patches, is printed on a substrate. Therefore, each calibration patch has a corresponding target patch. Each calibration patch in the calibration patch pattern also has a desired reflectance. Each target patch in the target patch pattern has a target reflectance that can be determined by measuring the target patch with a device that measures reflectances, such as a spectrophotometer. Each calibration patch's desired reflectance and the target reflectance of the corresponding target patch can be used as calibration data for determining knots.

In FIG. 6, an input highlight value 603 is shown. The input highlight value 603 is a value that is chosen as the lightest printable highlight value corresponding to the lowest nonzero input value on the TRC. In FIG. 6, a value of 1 is chosen for the input highlight value 603. This value is well within the highlight region and is not developable. In other words, a value of 1 can be specified and a marking engine can try to print it, but the printed result is far from certain. Extrapolation using the first knot 601 and second knot 602 can produce a target highlight value corresponding to the input highlight value 603. In FIG. 6, extrapolation determined a target highlight value of 6 604. A highlight knot 605 is denoted with a circle. The highlight knot indicates that an input value of 1 603 is mapped to an output value of 6 604.

In FIG. 6, two knots and an input highlight value are used to determine the highlight knot 605. When two knots are used, linear extrapolation produces adequate results. More knots can be used. Extrapolation, such as linear or polynomial extrapolation, of three or more knots can also produce adequate results.

Calibration data can be used to determine knots and those knots can be used to produce a TRC. However, that TRC does not work well in the highlight region because the algorithms used do not extrapolate well into that region. A highlight knot 605 can be used along with the other knots to produce a TRC. The algorithms used to produce TRCs produce better results when a knot, such as the highlight knot, anchors the TRC in the extreme highlight region.

As discussed above, calibration data in the shadow region can also be problematic. Knots cannot be determined in the shadow region without good shadow region calibration data. When there are no knots in that region, algorithms producing TRCs must extrapolate. As such, TRCs usually do not work well in the shadow region.

FIG. 7 shows two ways to define a shadow knot in the extreme shadow region. The illustration is not to scale. The maximum desired saturation for a color or black ink is the maximum amount of that ink that the marking engine will be asked to deposit. In FIG. 7, the maximum desired saturation is 255 because that is the extreme value along the input axis 701. The target saturation is the actual amount of ink that will be deposited. The target saturation can be chosen as the maximum amount of ink that the marking engine can deposit. A first shadow knot 703 is denoted as a solid triangle. The first shadow knot's maximum desired saturation is 255, as discussed above, and the target saturation is 255 because that is the maximum ink that can be deposited.

A second shadow knot 704 is denoted with an empty triangle. As above, it has a maximum desired saturation of 255. It has a target saturation of 240. The reason for a 240 target saturation value is that a person has specified that that is the most saturated color that should be printed. When a shadow knot with a user selected target saturation value is used, calibration data can be generated to help ensure that the target saturation value is consistent. When a person selects a color, they select an L*a*b* color coordinate, not a CMYK one, because L*a*b* color coordinates are invariant. When a user selects the most saturated color that should be printed, the user intends that the color not change, even if the amount of ink deposited does. A calibration patch can be printed with the user selected target saturation value. The reflectance of the corresponding target patch can be measured to produce calibration data for use in maintaining a consistent printed color corresponding to the maximum desired saturation.

As with the highlight knot, an algorithm producing TRCs from knots can also use a shadow knot. FIG. 7 illustrates a TRC 707 determined using eight knots 706 including one highlight knot 705 and one shadow knot 703. The type of knot is not relevant to most algorithms that produce TRCs from knots. Such algorithms usually treat all the knots as equivalent data points.

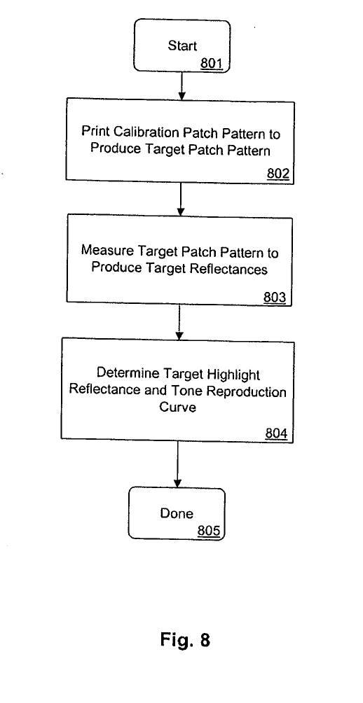

FIG. 8 illustrates a high level flow diagram of producing a TRC. After the start 801, a calibration patch pattern is printed to obtain a target patch pattern. As discussed above, the calibration patches in the calibration patch pattern have desired reflectances. The target patch pattern is measured to produce target reflectances 803. A target highlight value and a tone reproduction curve are determined 804 before the process is done 805. As discussed above, the calibration data used to produce the target highlight value and a tone reproduction curve includes the target reflectances, desired reflectances, and a desired target reflectance. The desired target reflectance can be obtained from a user or via linear extrapolation from two or three target reflectances and two or three desired reflectances.

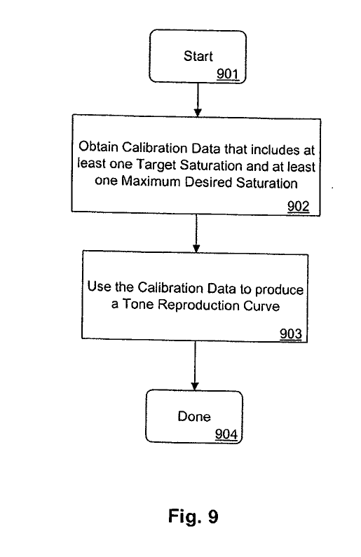

FIG. 9 also illustrates a high level flow diagram of producing a TRC. After the start 901, calibration data including at least one target saturation and at least one maximum desired saturation is obtained 902. The calibration data is used to produce a tone reproduction curve 903 before the process is done 904.

FIG. 8 and FIG. 9 differ in that FIG. 8 illustrates a process targeting highlight regions while FIG. 9 illustrates a process targeting shadow regions. Both processes use calibration data and can even use the same calibration data. The processes illustrated in the two figures can be combined to produce a TRC that works well in both the highlight regions and the shadow regions. Such a combined process can produce the TRC of FIG. 7.

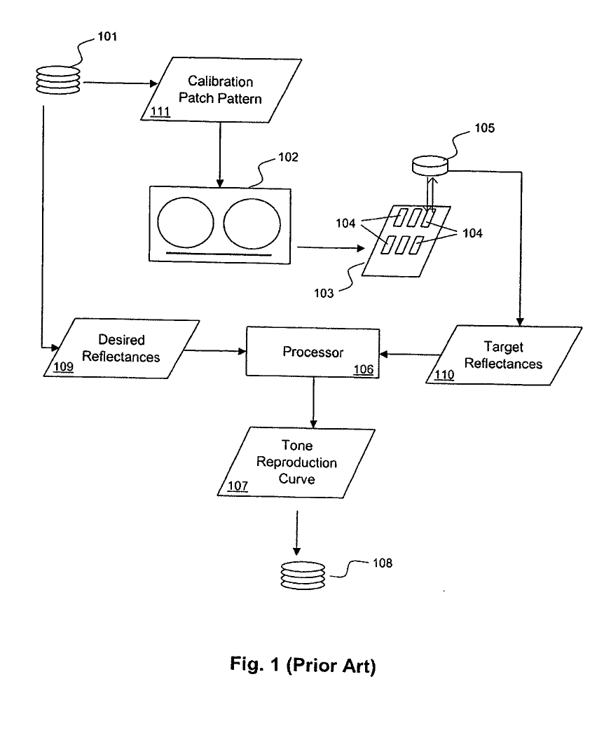

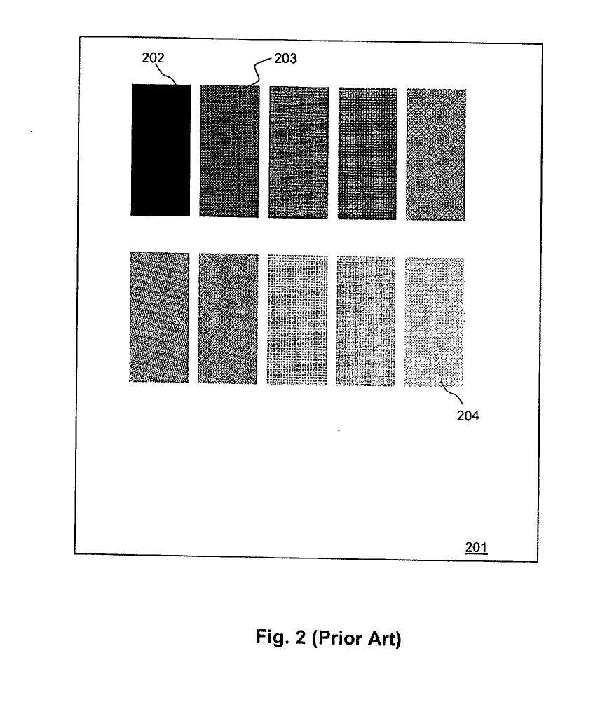

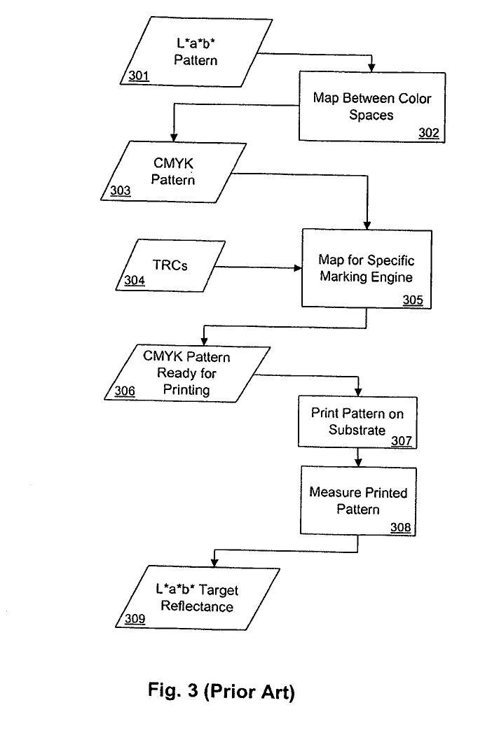

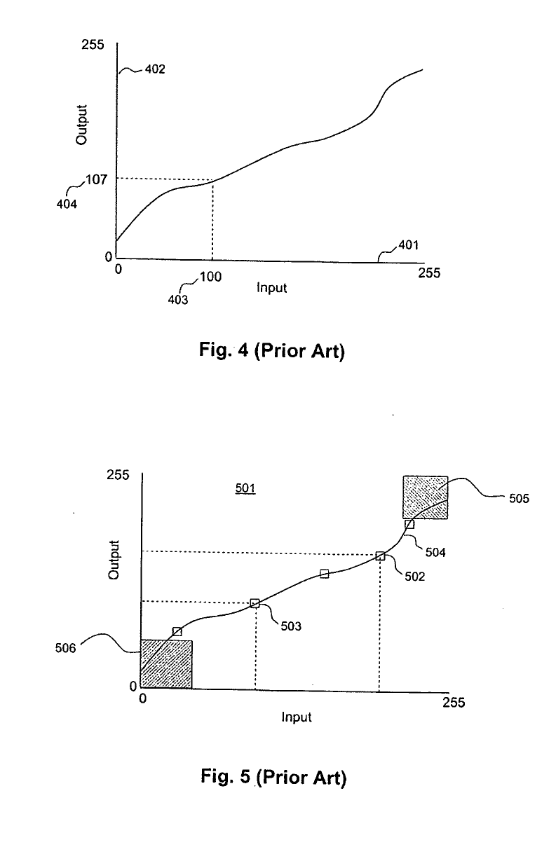

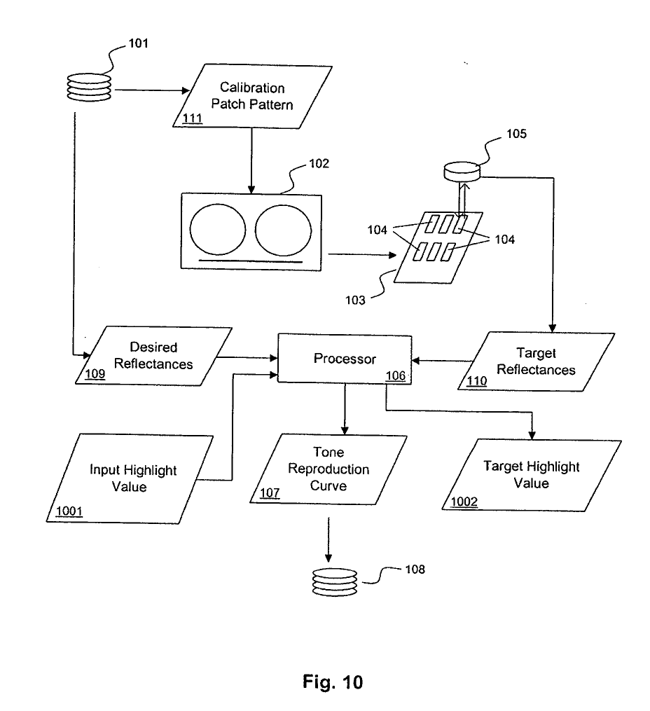

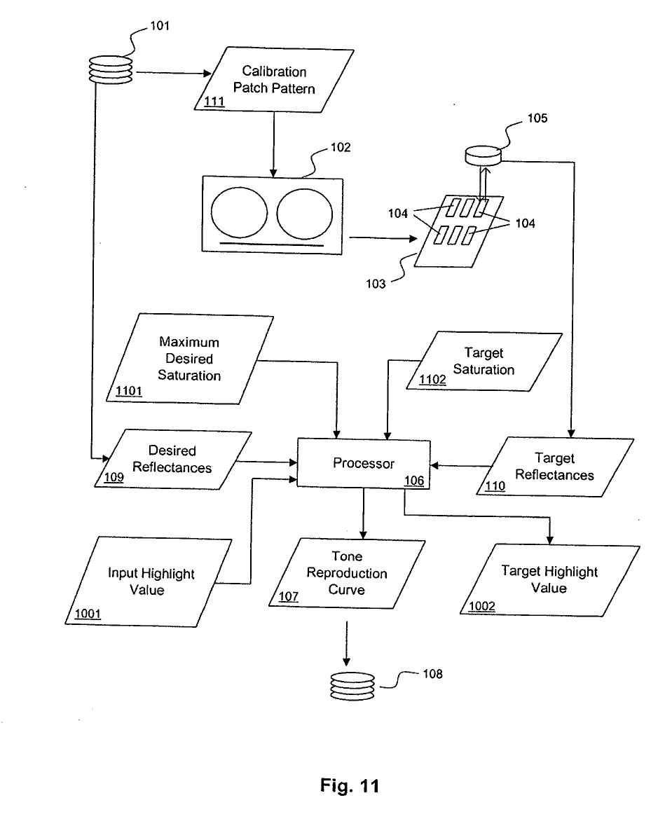

FIG. 10 illustrates a system for producing a TRC 107. It is similar to the system illustrated in FIG. 1. The elements in common between FIG. 1 and FIG. 10 will not be discussed here unless they function and interact in a different manner than discussed in relation to FIG. 1. The processor 106 uses an input highlight value 1001 as well as the desired reflectances 109 and target reflectances 110 to produce a target highlight value 1002 and a TRC 107. The TRC 107 can be stored in a storage device 108. As discussed above, the target highlight value can be obtained from a user or algorithmically.

FIG. 11 also illustrates a system for reproducing a TRC 107. It is similar to the system illustrated in FIG. 10. The difference is that the system of FIG. 11 specifically shows two additional data elements, a maximum desired saturation 1101 and a target saturation 1102, that are included in the calibration data passed to the processor 106.

The systems and methods illustrated in FIG. 8, FIG. 9, and FIG. 10 can also apply to the production of multiple TRCs. A different TRC is often required for every different ink used in a marking engine. Multiple TRCs can be obtained from the same calibration data because each color of ink can be treated independently. For example, process gray target patches can yield calibration data that can be used a cyan TRC, a magenta TRC, and a yellow TRC because the reflectances of the three inks can be easily distinguished. The reflectances of the three inks can even be easily distinguished within a single reflectance measurement of a process gray target patch or the desired reflectance of a process gray calibration patch. Given calibration data for all the inks, TRCs for all the inks can be determined.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
producing a target patch pattern by printing a calibration patch pattern on a substrate wherein said calibration patch pattern comprises at least two calibration patches that are developable and have at least two desired reflectances;
measuring said target patch pattern to obtain at least two target reflectances; and
determining a target highlight value from calibration data comprising an input highlight value, said at least two target reflectances and said at least two desired reflectances, thereby obtaining a target highlight value in a less developable region.

2. The method of claim 1 further comprising using said target highlight value and said calibration data to produce a tone reproduction curve.

3. The method of claim 1 wherein said at least two calibration patches comprise at least two calibration patches printed with black.

4. The method of claim 1 wherein said at least two calibration patches comprise at least two calibration patches printed with at least one primary color.

5. The method of claim 1 wherein said target highlight value is determined by linear extrapolation.

6. The method of claim 1 wherein said at least two calibration patches are three developable calibration patches.

7. A method comprising:
obtaining calibration data comprising at least one target saturation and at least one maximum desired saturation;
using said calibration data to produce a tone reproduction curve, thereby setting said tone reproduction curve for use in printing saturated areas.

8. The method of claim 7 wherein one of said at least one target saturation is a primary color's maximum possible saturation.

9. The method of claim 7 wherein one of said at least one target saturation is black's maximum possible saturation.

10. The method of claim 7 wherein said at least one target saturation is a user selected saturation.

11. The method of claim 10 further comprising producing a target patch by printing a calibration patch based on said user selected saturation, measuring a target reflectance of said target patch, and wherein said calibration data further comprises said target reflectance.

12. A system comprising:
a storage device adapted to store a calibration patch pattern comprising at least two calibration patches;
a marking engine that marks a substrate based on said calibration patch pattern to produce a target patch pattern;
a color measuring device that obtains at least two target reflectances from said target patch pattern;
a processor that determines at least one target highlight value and at least one tone reproduction curve from calibration data comprising an input highlight value and said at least two target reflectances;
a second storage device adapted to store said at least one tone reproduction curve.

13. The system of claim 12 wherein said calibration data further comprises at least one target saturation and at least one maximum desired saturation.

14. The system of claim 13 wherein said at least one target saturation comprises at least one primary color's maximum possible saturation.

15. The system of claim 13 wherein one of said at least one target saturation is black's maximum possible saturation.

16. The system of claim 13 wherein said at least one target saturation comprises at least one user selected saturation.

17. The system of claim 16 wherein at least one of said at least one calibration patch is based on said at least one user selected saturation and wherein said calibration data further comprises said at least one maximum desired saturation and said at least one user selected saturation.

18. The system of claim 12 wherein said processor uses linear extrapolation to produce said at least one target highlight value.

19. The system of claim 12 wherein said at least two calibration patches comprise at least two calibration patches printed with black.

20. The system of claim 12 wherein said at least two calibration patches comprise at least two calibration patches printed with at least one primary color.
